(19) United States
(12) Patent Application Publication
(10) Pub. No.: US 2022/0255064 A1
(43) Pub. Date: Aug. 11, 2022

(54) POSITIVE ELECTRODE ACTIVE MATERIAL FOR NONAQUEOUS ELECTROLYTE SECONDARY BATTERY, AND METHOD OF MANUFACTURING SAME

(71) Applicant: NICHIA CORPORATION, Anan-shi (JP)

(72) Inventors: Kenta KAWAI, Tokushima-shi (JP); Yoshiteru MIYAMOTO, Tokushima-shi (JP); Taiga SHIRAISHI, Anan-shi (JP); Yasuhiro YOSHIDA, Naka-gun (JP); Masahiro MURAYAMA, Tokushima-shi (JP); Tomoya MATSUI, Anan-shi (JP)

(73) Assignee: NICHIA CORPORATION, Anan-shi (JP)

(21) Appl. No.: 17/589,852

(22) Filed: Jan. 31, 2022

(30) Foreign Application Priority Data
Feb. 1, 2021 (JP) 2021-014351
Jan. 25, 2022 (JP) 2022-009253

(51) Int. Cl. H01M 4/36; H01M 4/525; H01M 4/505; H01M 10/0525; C01G 53/00

(52) U.S. Cl. CPC H01M 4/366; H01M 4/525; H01M 2004/028; H01M 10/0525; C01G 53/50; H01M 4/505

(57) ABSTRACT

The positive electrode active material includes secondary particles formed by aggregation of a plurality of primary particles that contain a lithium transition metal composite oxide having a layered structure and containing lithium and nickel. The secondary particles have a smoothness greater than 0.73, and a circularity greater than 0.83. The secondary particles contain cobalt and have a first region at a depth of 150 nm from a surface of the respective secondary particle and a second region at a depth of 10 nm or less from the surface of the respective secondary particle, and a ratio of a number of moles of cobalt to a total number of moles of metal elements other than lithium in the second region is larger than a ratio of a number of moles of cobalt to a total number of moles of metal elements other than lithium in the first region.

### CROSS-REFERENCE TO RELATED APPLICATIONS

This application claims priority to Japanese Patent Application No. 2021-014351, filed on Feb. 1, 2021, and Japanese Patent Application No. 2022-009253, filed on Jan. 25, 2022, the disclosures of which are hereby incorporated by reference in their entireties.

### BACKGROUND

### Field of the Invention

The present disclosure relates to a positive electrode active material for a nonaqueous electrolyte secondary battery and a method of manufacturing the same.

### Description of the Related Art

High output characteristics are required for electrode active materials for nonaqueous electrolyte secondary batteries used in large power equipment such as electric vehicles. To obtain high output characteristics, a positive electrode active material having a structure of secondary particles formed of many aggregated primary particles is thought to be effective. In this regard, techniques have been proposed for narrowing the particle size distribution of secondary particles, which are formed as a positive electrode active material by aggregation of primary particles into substantially spherical shapes. Such techniques are thought to allow increase in a capacity of a battery (see, e.g., WO 2013/183711). Also, techniques are also proposed for manufacturing a spherical nickel-cobalt-aluminum hydroxide precursor material by a coprecipitation method. Such techniques are thought allow improvement in cycle characteristics (see, e.g., WO 2016/180288).

On the other hand, techniques are proposed in which a coating layer containing Co is disposed on a surface of a positive electrode active material, which are thought to allow improvement in storage stability (weather resistance) while maintaining battery characteristics (see, e.g., Japanese Laid-Open Patent Publication No. 2018-14208).

### SUMMARY

According to a first aspect of the present disclosure, a positive electrode active material for a nonaqueous electrolyte secondary battery includes secondary particles formed by aggregation of a plurality of primary particles containing a lithium transition metal composite oxide having a layered structure and containing lithium and nickel. In the positive electrode active material for a nonaqueous electrolyte secondary battery, the smoothness of the secondary particles is greater than 0.73, and the circularity of the secondary particles is greater than 0.83. The secondary particles contain cobalt and have a first region at a depth of 150 nm from a surface of the respective secondary particle and a second region at a depth of 10 nm or less from the surface of the respective secondary particle, and a ratio of a number of moles of cobalt to a total number of moles of metal elements other than lithium in the second region is larger than a ratio of a number of moles of cobalt to a total number of moles of metal elements other than lithium in the first region.

According to a second aspect of the present disclosure, a method of manufacturing a positive electrode active material for a nonaqueous electrolyte secondary battery includes preparing a positive electrode active material raw material containing secondary particles formed by aggregation of a plurality of primary particles containing a lithium transition metal composite oxide having a layered structure and containing lithium and nickel, the secondary particles having the smoothness greater than 0.73, the secondary particles having the circularity greater than 0.83; bringing the positive electrode active material raw material into contact with a cobalt compound to obtain a cobalt-adhered material in which the cobalt compound is adhered to the positive electrode active material raw material; and heat-treating the cobalt-adhered material at a temperature of 500° C. or greater and lower than 1100° C. to obtain a heat-treated material.

According to a third aspect of the present disclosure, a nonaqueous electrolyte lithium-ion secondary battery includes: a positive electrode containing the electrode active material for a nonaqueous electrolyte secondary battery, a negative electrode, and a nonaqueous electrolyte.

### BRIEF DESCRIPTION OF DRAWINGS

FIG. 1 is a schematic cross-sectional view of an exemplary secondary particle contained in an exemplary positive electrode active material.

### DETAILED DESCRIPTION

The term “step” as used herein includes not only an independent step but also a step not clearly distinguishable from another step as long as the intended purpose of the step is achieved in the step. If a plurality of substances correspond to a component in a composition, the content of the component in the composition means the total amount of the plurality of substances present in the composition unless otherwise specified. Certain embodiments of the present disclosure will now be described in detail. It should be noted that the embodiments described below are exemplifications of a positive electrode active material for positive electrode active material for a nonaqueous electrolyte secondary battery and a method of manufacturing the same for embodying the technical ideas of the present disclosure, and the present disclosure is not limited to the positive electrode active material for a nonaqueous electrolyte secondary battery and the method of manufacturing the same described below.

### Positive Electrode Active Material for Nonaqueous Electrolyte Secondary Battery

A positive electrode active material for a nonaqueous electrolyte secondary battery (hereinafter, also simply referred to as “positive electrode active material”) contains secondary particles formed by aggregation of a plurality of primary particles containing a lithium transition metal composite oxide having a layered structure and containing lithium and nickel. The smoothness of the secondary particles constituting the positive electrode active material is greater than 0.73, and the circularity of the secondary particles is greater than 0.83. The secondary particles contain cobalt in composition and, for example, have cobalt-containing deposit on the surfaces of the particles. The secondary particles having the cobalt-containing deposits have a first region at a depth of 150 nm from the surface of the respective secondary particle and a second region at a depth of 10 nm or less from the surface of the respective secondary particle, and a ratio of the number of moles of cobalt to the total number of moles of metal elements other than lithium in the second region is larger than a ratio of the number of moles of cobalt to the total number of moles of metal elements other than lithium in the first region. According to an aspect of the present disclosure, a positive electrode active material for a nonaqueous electrolyte secondary battery can be provided that can improve output characteristics in a low state-of-charge (low SOC) when the nonaqueous electrolyte secondary battery is constructed.

When the secondary particles constituting the positive electrode active material have specific shapes specified by smoothness and circularity, for example, a contact area between the secondary particles and particles such as a conductive auxiliary agent in the positive electrode increases, and therefore, a resistance is thought to be reduced at an interface between the secondary particles and the conductive auxiliary agent. Further, when the cobalt-containing deposit is adhered to the surfaces of the secondary particles, uniform adhesion of the compound to be adhered can be facilitated, so that a resistance component can be reduced. Reduction of the resistance component in the positive electrode active material allows improvement in the output characteristics of the nonaqueous electrolyte secondary battery. Furthermore, the cracking of the secondary particles due to pressure molding can be reduced during formation of the positive electrode. This is thought to be caused by, for example, uniformly applying the pressure to the entire particles in the pressure molding. The effects derived from the secondary particles constituting the positive electrode active material are specifically described, for example, in WO2021/020531.

In the secondary particles of the lithium transition metal composite oxide constituting the positive electrode active material, cobalt is distributed predominantly at and near the surfaces of the particles and thus has an increased concentration at and near the surfaces of the particles. With this structure, the output characteristics can be improved when a battery is constructed using such a positive electrode active material. In particular, the output characteristics at low SOC can be improved. While the form of cobalt present near the surfaces of the particles is not clear, for example, cobalt may be in a state of a solid solution at or near the surfaces of the secondary particles of the lithium transition metal composite oxide, or a compound containing cobalt may coat the surfaces of the secondary particles of the lithium transition metal composite oxide. The effect of improving the output characteristics at low SOC due to the distribution of cobalt predominantly near the surfaces of the secondary particles tends to improve the output characteristics more effectively at low SOC when the nickel content ratio in the composition of the lithium transition metal composite oxide is high. This is thought to be due to that, for example, a potential difference between the lithium transition metal compound serving as the base material and the compound present at or near the surface allows lithium to move and diffuse without being hindered even at low SOC.

The positive electrode active material contains the secondary particles formed by aggregation of a plurality of primary particles containing a lithium transition metal composite oxide. The smoothness of the secondary particles constituting the positive electrode active material may be greater than 0.73, and the circularity of the secondary particles may be greater than 0.83. For example, the secondary particles are formed by aggregation of, for example, fifty or more primary particles. The positive electrode active material may be manufactured by using a method of manufacturing a positive electrode active material described below.

The smoothness of the secondary particles may be, for example, greater than 0.73, preferably 0.74 or greater, more preferably 0.76 or greater, 0.80 or greater, or 0.83 or greater. An upper limit of smoothness is 1. The “smoothness” used in the present specification is an index indicative of a degree of unevenness in the contour shape of the secondary particles. The smoother the shape is, the closer the smoothness is to 1, and the greater the degree of unevenness is, the closer the smoothness is to 0. The smoothness is obtained as follows. For a contour shape of an object secondary particle, an approximate ellipse having the same area as the contour shape of the object secondary particle is obtained by using a fitting function of an image processing software. From the major axis a and the minor axis b of the approximate ellipse, a total circumference L of the approximate ellipse is calculated using a formula of Gauss-Kummer. When the total circumference of the contour shape of the secondary particle is Lₒₚ and the total circumference of the approximate ellipse is L, the smoothness is defined as a ratio (L/Lₒₚ) of the total circumference (L) to the total circumference (Lₒₚ) of the contour shape of the secondary particle. A magnification of an image used for calculating the smoothness of the secondary particles may appropriately be selected depending on the particle diameter of the secondary particles. The magnification may be, for example, 1000 times or greater and 10000 times or less, preferably 1000 times or greater and 6000 times or less, and more preferably 2000 times or greater and 6000 times or less.

More specifically, a reflected electron image (magnification: 4000 times) is taken using a scanning electron microscope (SEM), ellipses each approximating a respective one of 20 to 40 secondary particles whose contours can be confirmed in the image are obtained, and the major axis a and the minor axis b of each of the ellipses are determined. Additionally, the total circumference Lₒₚ of the contour shape is measured. From the major axis a and the minor axis b, the total circumference L of the ellipse approximated based on the following approximation formula is calculated to obtain the ratio (L/Lₒₚ) for each of the secondary particles, and the smoothness of the secondary particles is calculated as an arithmetic mean value thereof. The expression “the contour of the secondary particle can be confirmed” means that the entire contour of the secondary particle can be traced on the image.

$$L = π ( a + b ) \{ 1 + {( \frac{1}{2} )}^{2} {h}^{2} + {( \frac{1}{2 \cdot 4} )}^{2} {h}^{4} + {( \frac{1 \cdot 3}{2 \cdot 4 \cdot 6} )}^{2} {h}^{6} \}$$

$$where h = \frac{a - b}{a + b}$$

The circularity of the secondary particles may be, for example, greater than 0.83, preferably 0.84 or greater, more preferably 0.86 or greater, or 0.90 or greater. The upper limit of the circularity is 1. The circularity is an index indicative of a degree of circularity of the contour shape of the secondary particles, and the closer the shape is to a circle, the closer the index is to 1. When a diameter of a circle having an area same as a particle image area of the contour shape of the secondary particle is defined as an equivalent circle diameter, the circularity is defined as a ratio (L₁/L₀) of a circumference (L₁) calculated from the equivalent circle diameter to a total circumference (L₀) of the contour shape of the secondary particle.

More specifically, by using a dry particle image analyzer (Morphologi G3S: Malvern; lens magnification: 20 times), respective ratios (L₁/L₀) are calculated for about 10,000 particles, and the arithmetic mean value of the obtained ratios (L₁/L₀) is determined as the circularity of the secondary particles.

The particle size distribution value of the secondary particles may be, for example, less than 0.9, preferably 0.85 or less, and more preferably 0.8 or less. The particle size distribution value is an index indicative of a variation in particle diameters of individual secondary particles of the plurality of secondary particles, and a smaller particle size distribution value indicates a smaller variation in the particle diameters. With the particle size distribution value of the secondary particles being within the range, when causing another element to adhere to the surfaces of the secondary particles, the element can be facilitated to uniformly adhere to the surfaces of the secondary particles. In the present specification, the particle size distribution value is defined as follows. When particle diameters corresponding to 10%, 50%, and 90% of accumulation from the small diameter side in the volume-based cumulative particle size distribution are a 10% particle diameter D₁₀, a 50% particle diameter D₅₀, and a 90% particle diameter D₉₀, respectively, a value obtained by dividing a difference between D₉₀ and D₁₀ by D₅₀ is defined as the particle size distribution value in the present specification. Therefore, the particle size distribution value of the secondary particles is defined by the following equation.

Particle size distribution value=(D₉₀-D₁₀)/D₅₀

In the present specification, the volume-based cumulative particle size distribution is measured under wet condition by using a laser diffraction particle size distribution measuring device.

A volume average particle diameter of the secondary particles may be, for example, 1 μm or greater and 30 μm or less, preferably 2 μm or greater, more preferably 3 μm or greater, and preferably 12 μm or less, more preferably 8 μm or less. The volume average particle diameter of the secondary particles within the range may result in good fluidity and further improvement in output when the secondary battery is formed. In the present specification, the “volume average particle diameter” refers to the 50% particle diameter D₅₀ corresponding to 50% accumulation from the small diameter side in a volume-based cumulative particle size distribution.

The secondary particles are formed by aggregation of the plurality of primary particles. An average particle diameter D_{SEM} of the primary particles based on electron microscope observation may be, for example, 0.1 μm or greater and 1.5 μm or less, preferably 0.12 μm or greater, more preferably 0.15 μm or greater, 0.2 μm or greater, or 0.3 μm or greater. The average particle diameter D_{SEM} of the primary particles based on electron microscope observation is preferably 1.2 μm or less, more preferably 1.0 μm or less, 0.6 μm or less, or 0.4 μm or less. When the average particle diameter of the primary particles based on electron microscope observation is within the range, the output may be improved when the battery is formed. The average particle diameter of the primary particles based on electron microscope observation is measured as follows. By using a scanning electron microscope (SEM), the primary particles constituting the secondary particles are observed at a magnification in the range of 1000 to 15000 times depending on a particle diameter. Fifty primary particles whose contours can be confirmed in the observation are selected, equivalent spherical diameters are calculated from the contours of the selected primary particles by using image processing software, and the arithmetic mean value of the obtained equivalent spherical diameters is determined as the average particle diameter of the primary particles based on electron microscope observation. In one embodiment, the primary particle may have a particle adhering to the surface thereof and having an average particle diameter smaller than the primary particle. In an embodiment, the primary particle may be an aggregate of particles having an average particle diameter smaller than the primary particle. The average particle diameter of the particles having an average particle diameter smaller than the primary particle described above may be measured based on electron microscopic observation in the same manner as described above. The expression “the contour of the primary particle can be confirmed” means that the entire contour of the primary particle can be traced on the image.

The secondary particles may have a ratio D₅₀/D_{SEM} of the 50% particle diameter D₅₀ in the volume-based cumulative particle size distribution to the average particle diameter D_{SEM} based on electron microscope observation of 2.5 or greater, for example. The ratio D₅₀/D_{SEM} is, for example, 2.5 or greater and 150 or less, preferably 5 or greater, more preferably 10 or greater, or 15 or greater. The ratio D₅₀/D_{SEM} is preferably 100 or less, more preferably 50 or less, 30 or less, or 20 or less.

The secondary particle containing the lithium transition metal composite oxide constituting the positive electrode active material has a first region and a second region in the vicinity of the surface of the positive electrode active material. The first region is located at a depth of around 150 nm from the surface of the secondary particle, and the second region is located at a depth of 10 nm or less from the surface of the secondary particle. In the positive electrode active material, the ratio of the number of moles of cobalt to the total number of moles of metal elements other than lithium in the composition (hereinafter, also simply referred to as “cobalt ratio”) is larger in the second region than in the first region. The second region is located at a depth of for example, 10 nm or less from the surface of the secondary particle in the example herein, but may be located at a depth of around 10 nm from the surface of the secondary particle.

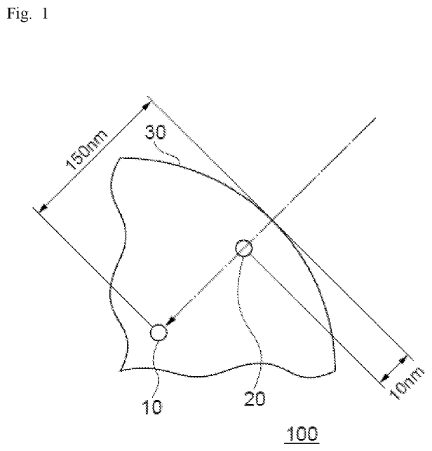

An exemplary method of selecting the first region and the second region in a cross-sectional image of the secondary particle will be described with reference to the drawing. FIG. 1 is a schematic cross-sectional view of an exemplary secondary particle. For example, a first region 10 is selected as will be described below. A tangent line to a surface of the secondary particle 30 is set in a cross-sectional image of a secondary particle 100, a perpendicular line orthogonal to the tangent line is then drawn through the contact point therebetween, and the first region 10 is defined in the vicinity of a point on the perpendicular line at a distance of 150 nm from the surface of the secondary particle 30 in a particle-inward direction. Similarly, the second region 20 is selected in the vicinity of a point on the perpendicular line at a distance of 10 nm from the surface of the secondary particle 30 in the particle-inward direction. The term “vicinity” in this case is intended to include a region having an area dimension required for composition analysis. The depth of the first region from the surface of the secondary particle may be, for example, in a range of 140 nm to 160 nm, and the depth of the second region from the surface of the secondary particle may be, for example, in a range of 5 nm to 15 nm.

The cobalt ratio of the first region may be, for example, 0 or greater, preferably 0.01 or greater, more preferably 0.02 or greater, further preferably 0.025 or greater, or 0.03 or greater. The cobalt ratio of the first region may be, for example, 0.5 or less, preferably 0.3 or less, more preferably 0.2 or less, further preferably 0.1 or less, or 0.05 or less. The cobalt ratio of the second region may be, for example, 0.03 or greater, preferably 0.05 or greater, more preferably 0.1 or greater, further preferably 0.15 or greater. The cobalt ratio of the second region may be, for example, 0.9 or less, preferably 0.8 or less, more preferably 0.5 or less, particularly preferably 0.3 or less, or 0.2 or less. A value obtained by subtracting the cobalt ratio of the first region from the cobalt ratio of the second region may be, for example, 0.02 or greater, preferably 0.03 or greater and 0.85 or less, or 0.05 or greater and 0.50 or less. A value obtained by dividing the cobalt ratio of the second region by the cobalt ratio of the first region may be, for example, 2 or greater, preferably 2.2 or greater and 500 or less, more preferably 2.5 or greater and 100 or less, further preferably 3 or greater and 10 or less. When the cobalt ratio in specific composition is within the range, the output characteristics at low SOC may be improved.

A ratio of the number of moles of nickel to the total number of moles of metal elements other than lithium in the first region at the depth of around 150 nm from the surface of the secondary particle (hereinafter, also simply referred to as “nickel ratio”) may be, for example, 0.2 or greater and is preferably 0.33 or greater, more preferably 0.6 or greater, 0.8 or greater, or 0.9 or greater. The nickel ratio of the first region may be, for example, 1 or less, and is preferably 0.98 or less, more preferably 0.95 or less. The nickel ratio in the second region at the depth of 10 nm or less from the surface of the secondary particle may be, for example, 0.06 or greater, and is preferably 0.1 or greater, more preferably 0.33 or greater, 0.5 or greater, or 0.6 or greater. The nickel ratio of the second region may be, for example, 0.98 or less, preferably 0.95 or less, and more preferably 0.9 or less, 0.85 or less, or 0.8 or less. Furthermore, a value obtained by dividing the nickel ratio of the second region by the nickel ratio of the first region may be, for example, less than 1, and is preferably 0.9 or less or 0.85 or less. A value obtained by dividing the nickel ratio of the second region by the nickel ratio of the first region may be, for example, 0.02 or greater, and is preferably 0.03 or greater or 0.07 or greater.

The nickel ratio and the cobalt ratio in the first region and the second region can be calculated by measuring SEM-EDX in a cross section of lithium transition metal composite oxide particles.

In the lithium transition metal composite oxide particle, the cobalt ratio may decrease continuously or discontinuously from the particle surface to the inside of the particle. A concentration gradient of cobalt is defined as an absolute value obtained by dividing a difference in the ratio of the number of moles of cobalt to the total number of moles of metal elements other than lithium between the first region and the second region by a difference in depth of the first region and the second region from the surface of the lithium transition metal composite oxide particle and is, for example, greater than 0.0000007 (nm⁻¹) and less than 0.005 (nm⁻¹), preferably 0.00005 (nm⁻¹) or greater and 0.003 (nm⁻¹) or less, or 0.0001 (nm⁻¹) or greater and 0.002 (nm⁻¹) or less. When the concentration gradient of cobalt is within the range described above, the output at low SOC tends to be further improved. More specifically, the concentration gradient of cobalt is obtained by dividing a value obtained by subtracting the cobalt ratio in the first region from the cobalt ratio in the second region by a value obtained by subtracting the depth of a location of the second region from the surface of the lithium transition metal composite oxide particle from the depth of a location of the first region from the surface of the particle.

The composition of the positive electrode active material can be considered as a composition including a cobalt compound adhering to the composition of the lithium transition metal composite oxide before adhesion of the cobalt compound in a manufacturing method described later.

The ratio of the number of moles of nickel to the total number of moles of metal elements other than lithium in the composition of the positive electrode active material may be, for example, greater than 0 and less than 1, preferably 0.3 or greater and less than 1. The lower limit of the ratio of the number of moles of nickel to the total number of moles of metal elements other than lithium may be preferably 0.33 or greater, more preferably 0.6 or greater, or 0.8 or greater. The upper limit of the ratio of the number of moles of nickel to the total number of moles of metal elements other than lithium may be preferably 0.98 or less, and more preferably 0.95 or less. When the ratio of the number of moles of nickel is within the range described above, a charge/discharge capacity at high voltage and cycle characteristics both tend to be increased in the nonaqueous electrolyte secondary battery.

The ratio of the number of moles of cobalt to the total number of moles of metal elements other than lithium in the composition of the positive electrode active material may be, for example, greater than 0 and 0.5 or less and, in view of charge/discharge capacity, may be preferably 0.01 or greater and 0.4 or less, more preferably 0.02 or greater and 0.3 or less, further preferably 0.03 or greater and 0.2 or less, and particularly preferably 0.04 or greater and 0.1 or less. When the ratio of the number of moles of cobalt to the total number of moles of metal elements other than lithium is within the range described above, the output at low SOC tends to be further improved.

The composition of the positive electrode active material may further contain at least one first metal element M¹ selected from the group consisting of manganese (Mn) and aluminum (Al). In the composition of the positive electrode active material, a ratio of the number of moles of M¹ to the total number of moles of metal elements other than lithium may be, for example, 0 or greater and 0.5 or less and, from the viewpoint of safety, may be preferably 0.01 or greater and 0.3 or less, more preferably 0.02 or greater and 0.2 or less, and further preferably 0.03 or greater and 0.1 or less.

The composition of the positive electrode active material may further contain at least one second metal element M² selected from the group consisting of boron (B), sodium (Na), magnesium (Mg), silicon (Si), phosphorus (P), sulfur (S), potassium (K), calcium (Ca), titanium (i), vanadium (V), chromium (Cr), iron (Fe), copper (Cu), zinc (Zn), gallium (Ga), strontium (Sr), yttrium (Y), zirconium (Zr), niob (Nb), molybdenum (Mo), indium (In), tin (Sn), barium (Ba), lanthanum (La), cerium (Ce), neodymium (Nd), samarium (Sm), europium (Eu), gadolinium (Gd), lutetium (Lu), tantalum (Ta), tungsten (W), bismuth (Bi), etc.

The second metal element M² may be at least one selected from the group consisting of Zr, Ti, Mg, Ta, Nb, Mo, and W. In the composition of the positive electrode active material, a ratio of the number of moles of M² to the total number of moles of metal elements other than lithium may be, for example, 0 or greater and 0.1 or less, preferably 0.001 or greater and 0.05 or less.

The ratio of the number of moles of lithium to the total number of moles of metal elements other than lithium in the composition of the positive electrode active material may be, for example, 0.95 or greater and 1.5 or less, preferably 1 or greater and 1.3 or less, more preferably 1.03 or greater and 1.25 or less.

In the composition of the positive electrode active material, the molar ratio of nickel, cobalt, and manganese may be, for example, nickel:cobalt:manganese=(0.3 or greater and less than 1):(0.01 to 0.4):(0.01 to 0.3), preferably (0.33 to 0.98):(0.02 to 0.3):(0.02 to 0.2), more preferably (0.6 to 0.98):(0.03 to 0.2):(0.03 to 0.1).

The composition of the positive electrode active material may be represented by Formula (1), for example.

LiₚNiₓCo_{y}M¹_{z}M²_{w}O₂ (1)

wherein 0.95≤p≤1.5, 0<x<1, 0<y≤0.5, 0≤0.5, 0≤w≤0.1, and x+y+z+w≤1. M¹ is at least one selected from the group consisting of Al and Mn, and M² is at least one selected from the group consisting of B, Na, Mg, Si, P, S, K, Ca, Ti, V, Cr, Fe, Cu, Zn, Ga, Sr, Y, Zr, Nb, Mo, In, Sn, Ba, La, Ce, Nd, Sm, Eu, Gd, Lu, Ta, W, and Bi. Additionally, x, y, z, and w may satisfy 0.3≤x<1, 0.01≤y≤0.4, 0.01≤z≤0.3, 0≤w≤0.1 and may satisfy 0.33≤x≤0.98, 0.02≤y≤0.3, 0.02≤z≤0.2, 0≤w≤0.1, or 0.6≤x≤0.98, 0.03≤y≤0.2, 0.03≤z≤0.1, 0.001≤w≤0.05, and p may satisfy 1≤p≤1.3.

In the lithium transition metal composite oxide contained in the positive electrode active material, a nickel element disorder obtained by the X-ray diffraction method is preferably 4.0% or less, more preferably 2.0% or less, further preferably 1.5% or less, in view of initial efficiency in the nonaqueous electrolyte secondary battery. The term “nickel element disorder” in the present specification means a chemical disorder of transition metal ions (nickel ions) that should occupy original sites. In the lithium transition metal composite oxide having a layered structure, a typical example of such disorder is a replacement between an alkali metal ion that should occupy a site represented by 3b (3b site, the same applies hereinafter) and a transition metal ion that should occupy a 3a site when denoted by the Wyckoff symbols. The smaller the nickel element disorder, the better the initial efficiency, and thus the more preferable.

The nickel element disorder in the lithium transition metal composite oxide can be determined by an X-ray diffraction method. The X-ray diffraction spectrum of the lithium transition metal composite oxide is measured with a CuKα ray. With a composition model set to (Li_{1-d}Ni_{d})(NiₓCo_{y}Mn_{z})O₂ (x+y+z=1), the structural optimization is performed by Rietveld analysis based on the obtained X-ray diffraction spectrum. The percentage of d calculated as a result of the structural optimization is obtained as the value of the nickel element disorder.

Method of Manufacturing Positive Electrode Active Material

A method of manufacturing a positive electrode active material may include, for example, a positive electrode active material raw material preparation step of preparing a positive electrode active material raw material that contains the secondary particles formed by aggregation of a plurality of primary particles that contain a lithium transition metal composite oxide, the lithium transition metal composite oxide having a layered structure and containing lithium and nickel, the secondary particles having a smoothness greater than 0.73 and a circularity greater than 0.83, a cobalt adhesion step of bringing the positive electrode active material raw material with a cobalt compound to obtain a cobalt-adhered material, and a deposit heat treatment step of heat-treating the cobalt-adhered material at a temperature of 500° C. or greater and lower than 1100° C. to obtain a heat-treated material.

The positive electrode active material raw material preparation step in the method of manufacturing a positive electrode active material may include, for example, a composite oxide preparation step of preparing a nickel composite oxide that contains secondary particles formed by aggregation of a plurality of primary particles containing a composite oxide containing nickel, the secondary particles having a smoothness of the secondary particles greater than 0.74, a lithium mixing step of mixing a nickel composite oxide and a lithium compound to obtain a lithium mixture, and a synthesis step of heat-treating the lithium mixture to obtain a lithium transition metal composite oxide containing nickel and having a layered structure. The prepared positive electrode active material raw material contains the secondary particles formed by aggregation of the plurality of primary particles containing the lithium transition metal composite oxide. The smoothness of the secondary particles may be greater than 0.73. The circularity of the secondary particles may be greater than 0.83.

The positive electrode active material raw material preparation step in the method of manufacturing a positive electrode active material may further include preparing a first solution containing nickel ions, preparing a second solution containing a complex ion forming factor, preparing a liquid medium having pH in a range of 10 or greater and 13.5 or less, supplying a polymer containing a constitutional unit derived from (meth)acrylic acid while separately and simultaneously supplying the first solution and the second solution, to obtain a reaction solution having pH maintained in the range of 10 or greater and 13.5 or less, obtaining a composite hydroxide containing nickel from the reaction solution, heat-treating the composite hydroxide to obtain a nickel composite oxide containing the secondary particles formed by aggregation of the plurality of primary particles containing the complex oxide containing nickel, mixing the nickel composite oxide and a lithium compound to obtain a lithium mixture, and heat-treating the lithium mixture.

### Positive Electrode Active Material Raw Material Preparation Step

### Composite Oxide Preparation Step

In the composite oxide preparation step, a nickel composite oxide is prepared that contains the secondary particles formed by aggregation of the plurality of primary particles containing a composite oxide containing nickel. The smoothness of the secondary particles containing the nickel composite oxide may be greater than 0.74. The nickel composite oxide may be prepared by appropriately selecting from commercially available products or by manufacturing in a method of manufacturing a nickel composite oxide to be described below. Details of the prepared nickel composite oxide will be described below.

### Lithium Mixing Step

In the lithium mixing step, the prepared nickel composite oxide and the lithium compound are mixed to obtain a lithium mixture. Examples of a method of the mixing include a method in which the nickel composite oxide and the lithium compound are dry-mixed by an agitator/mixer etc., and a method in which a slurry of the nickel composite oxide is prepared and is wet-mixed by using a mixer such as a ball mill. Examples of the lithium compound include lithium hydroxide, lithium nitrate, lithium carbonate, and a mixture thereof.

A ratio of the number of moles of lithium to the total number of moles of metal elements other than lithium in the lithium mixture (also referred to as a lithium ratio) may be, for example, 0.95 or greater and 1.5 or less, preferably 1.0 or greater and 1.30 or less. When the lithium ratio is 0.90 or greater, formation of by-products tends to be reduced. When the lithium ratio is 1.5 or less, an increase in amount of an alkaline component present on the surface of the lithium mixture is reduced, and the water adsorption due to a deliquescent property of the alkaline component is reduced, so that the handling tends to be improved.

### Synthesis Step

In the synthesis step, the lithium mixture is heat-treated to obtain a lithium transition metal composite oxide containing nickel and having a layered structure. The lithium transition metal composite oxide is contained in the primary particles, and the secondary particles formed by aggregation of the plurality of primary particles are contained in the positive electrode active material raw material. In the synthesis step, the lithium transition metal composite oxide may be obtained through diffusion of lithium contained in the lithium compound into the nickel composite oxide.

The heat treatment temperature may be, for example, 600° C. or greater and 990° C. or less, preferably 650° C. or greater and 960° C. or less. When the heat treatment temperature is 600° C. or greater, an increase of the unreacted lithium component tends to be suppressed. When the heat treatment temperature is 990° C. or less, decomposition of the formed lithium transition metal composite oxide tends to be reduced. The heat treatment time may be, for example, 4 hours or more, as a time of maintaining a maximum temperature. The heat treatment may be performed in the presence of oxygen, preferably in an atmosphere containing 10 vol. % or greater and 100 vol. % or less of oxygen.

In the positive electrode active material raw material preparation step, after the synthesis step, the obtained heat-treated material may be subjected to rough crushing, pulverization, dry sieving etc., if necessary.

The lithium transition metal composite oxide contained in the positive electrode active material raw material obtained in the positive electrode active material raw material preparation step may contain nickel in composition and have a layered structure, for example. The lithium transition metal composite oxide may contain at least a transition metal such as Li and Ni and may further contain at least one primary metal element selected from the group consisting of Al and Mn. The lithium transition metal composite oxide may further contain at least one second metal element selected from the group consisting of B, Na, Mg, Si, P, S, K, Ca, Ti, V, Cr, Fe, Cu, Zn, Ga, Sr, Y, Zr, Nb, Mo, In, Sn, Ba, La, Ce, Nd, Sm, Eu, Gd, Lu, Ta, W, and Bi. The second metal element may be at least one selected from the group consisting of Zr, Ti, Mg, Ta, Nb, Mo, and W.

In the composition of the lithium transition metal composite oxide contained in the positive electrode active material raw material, the ratio of the number of moles of nickel to the total number of moles of metal elements other than lithium is, for example, greater than 0, preferably 0.3 or greater. The ratio of the number of moles of nickel to the total number of moles of metal elements other than lithium may be 0.33 or greater, or 0.6 or greater. The ratio of the number of moles of nickel to the total number of moles of metal elements other than lithium is, for example, less than 1, preferably 0.98 or less, and more preferably 0.95 or less. When the ratio of the number of moles of nickel is in the range described above, the charge/discharge capacity at high voltage and the cycle characteristics both tend to be improved in the nonaqueous electrolyte secondary battery.

In the composition of the lithium transition metal composite oxide contained in the positive electrode active material raw material, the ratio of the number of moles of cobalt to the total number of moles of metal elements other than lithium is, for example, 0 or greater, preferably 0.01 or greater, and more preferably 0.02 or greater, further preferably 0.03 or greater, particularly preferably 0.04 or greater. The ratio of the number of moles of cobalt to the total number of moles of metal elements other than lithium is, for example, 0.5 or less, preferably 0.4 or less, more preferably 0.3 or less, further preferably 0.2 or less, or may be 0.1 or less. When the ratio of the number of moles of cobalt is within the range described above, the charge/discharge capacity may be further increased at high voltage in the nonaqueous electrolyte secondary battery. When the ratio of the number of moles of cobalt is within the range described above, the output at low SOC tends to be further improved.

In the composition of the lithium transition metal composite oxide contained in the positive electrode active material raw material, a ratio of the total number of moles of manganese and aluminum to the total number of moles of metal elements other than lithium is, for example, 0 or greater, preferably 0.01 or greater, more preferably 0.02 or greater, further preferably 0.03 or greater. The ratio of the total number of moles of manganese and aluminum to the total number of moles of metal elements other than lithium is, for example, 0.5 or less, preferably 0.3 or less, more preferably 0.2 or less, or 0.1 or less. When the ratio of the total number of moles of manganese and aluminum is within the range described above, improvement in both charge/discharge capacity and safety tend to be facilitated in the nonaqueous electrolyte secondary battery.

In the composition of the lithium transition metal composite oxide contained in the positive electrode active material raw material, the ratio of the number of moles of lithium to the total number of moles of metal elements other than lithium is, for example, 0.95 or greater, preferably 1.0 or greater, more preferably 1.03 or greater, further preferably 1.05 or greater. The ratio of the number of moles of lithium to the total number of moles of metal elements other than lithium is, for example, 1.5 or less, preferably 1.3 or less, more preferably 1.25 or less, further preferably 1.2 or less. When the ratio of the number of moles of lithium is 0.95 or greater, the interfacial resistance of the positive electrode surface is reduced in the nonaqueous electrolyte secondary battery using the positive electrode active material containing the obtained lithium transition metal composite oxide, so that the output of the nonaqueous electrolyte secondary battery tends to be improved. On the other hand, when the ratio of the number of moles of lithium is 1.5 or less, an initial discharge capacity tends to be improved when the positive electrode active material is used for the positive electrode of the nonaqueous electrolyte secondary battery.

In the composition of the lithium transition metal composite oxide contained in the positive electrode active material raw material, a ratio of the numbers of moles of nickel, cobalt, and manganese may be, for example, nickel:cobalt:manganese=(0.3 or greater and less than 1):(0.01 to 0.4):(0.01 to 0.3), preferably (0.33 to 0.98):(0.02 to 0.3):(0.02 to 0.2), more preferably (0.6 to 0.98):(0.03 to 0.2):(0.03 to 0.1). When the lithium transition metal composite oxide contains cobalt as well as manganese and aluminum in addition to nickel, the ratio of the numbers of moles of nickel, cobalt, and (manganese+aluminum) is, for example, nickel:cobalt:(manganese+aluminum)=(0.3 to less than 1):(0.01 to 0.4):(0.01 to 0.4), preferably (0.33 to 0.98):(0.02 to 0.3):(0.02 to 0.2).

In the composition of the lithium transition metal composite oxide contained in the positive electrode active material raw material, a ratio of the total number of moles of the second metal element to the total number of moles of the metal element other than lithium is, for example, 0 or greater, preferably 0.001 or greater, more preferably 0.003 or greater. The ratio of the total number of moles of the second metal element to the total number of moles of the metal element other than lithium is, for example, 0.1 or less, preferably 0.05 or less, more preferably 0.01 or less.

The lithium transition metal composite oxide contained in the positive electrode active material raw material may be represented by a composition formula of Formula (2), for example. The lithium transition metal composite oxide may have a layered structure and may have a hexagonal crystal structure.

Liₚ₁Niₓ₁Co_{y1}M¹_{z1}M²_{w1}O₂ (2)

In this formula, p1, x1, y1, z1, and w1 satisfy 0.95≤p1≤1.5, 0.3≤x1≤1, 0≤y1≤0.5, 0≤z1≤0.5, 0≤w1≤0.1 and x1+y1+z1+w1≤1. Preferably, 0.33≤x1≤0.98, 0.01≤y1≤0.4, 0.01≤z1<0.3, 0≤w1≤0.1, and more preferably 0.6≤x1≤0.98, 0.03≤y1≤0.2, 0.03≤z1≤0.1, 0.001≤w1≤0.05 are satisfied.

M¹ may denote at least one of Mn and Al. M² may denote at least one selected from the group consisting of B, Na, Mg, Si, P, S, K, Ca, Ti, V, Cr, Fe, Cu, Zn, Ga, Sr, Y, Zr, Nb, Mo, In, Sn, Ba, La, Ce, Nd, Sm, Eu, Gd, Lu, Ta, W, and Bi, and may denote at least one selected from the group consisting of Zr, Ti, Mg, Ta, Nb, Mo, and W.

The 50% particle diameter D₅₀ of the positive electrode active material raw material is, for example, 1 μm or greater and 30 μm or less, preferably 1.5 μm or greater, more preferably 3 μm or greater, and is preferably 10 μm or less, more preferably 5.5 μm or less, from the viewpoint of output density.

A ratio of the 90% particle diameter D₉₀ to the 10% particle diameter D₁₀ in the volume-based cumulative particle size distribution of the positive electrode active material raw material indicates a spread of the particle size distribution, and when the value is smaller, the particle size is more uniform. D₉₀/D₁₀ may be, for example, 4 or less, and is preferably 3 or less, more preferably 2.5 or less, in view of output density. The lower limit of D₉₀/D₁₀ may be 1.2 or greater, for example.

### Cobalt Adhesion Step

In the cobalt adhesion step, the prepared positive electrode active material raw material and the cobalt compound are brought into contact with each other to obtain a cobalt-adhered material in which the cobalt compound adheres to a surface of the lithium transition metal composite oxide contained in the positive electrode active material raw material. The contact between the positive electrode active material raw material and the cobalt compound may be performed in a dry process or a wet process. When performing in a dry process, for example, the positive electrode active material raw material and the cobalt compound may be mixed by using a high-speed shearing mixer etc., to be brought into contact with each other. Examples of the cobalt compound include cobalt hydroxide, cobalt oxide, and cobalt carbonate.

When performing in wet process, the positive electrode active material raw material can be brought into contact with a liquid medium containing the cobalt compound to bring the positive electrode active material raw material and the cobalt compound into contact with each other. In this case, the liquid medium may be stirred if necessary. For the liquid medium containing the cobalt compound, a solution of the cobalt compound or a dispersion liquid of the cobalt compound may be used. Alternatively, the positive electrode active material raw material may be suspended in a solution of the cobalt compound, and the cobalt compound may be precipitated in the solution by pH adjustment, temperature adjustment, etc., to cause the cobalt compound to adhere to the surface of the lithium transition metal composite oxide particles contained in the positive electrode active material raw material.

Examples of the cobalt compound contained in the solution include cobalt sulfate, cobalt nitrate, cobalt chloride, etc. Examples of the cobalt compound contained in the dispersion liquid include cobalt hydroxide, cobalt oxide, and cobalt carbonate. The liquid medium may contain water, for example, and may contain a water-soluble organic solvent such as alcohol in addition to water. The concentration of the cobalt compound in the liquid medium can be, for example, 1 mass % or greater and 8.5 mass % or less.

A total amount of the cobalt compound to be brought into contact with the positive electrode active material raw material is, for example, 1 mol % or greater and 20 mol % or less, preferably 3 mol % or greater and 15 mol % or less, based on cobalt, relative to the lithium transition metal composite oxide contained in the positive electrode active material raw material.

The contact temperature between the positive electrode active material raw material and the cobalt compound can be, for example, 40° C. or greater and 80° C. or less, preferably 40° C. or greater and 60° C. or less. The contact temperature may be, for example, 20° C. or greater and 80° C. or less. The contact time is, for example, 30 minutes or greater and 180 minutes or less, preferably 30 minutes or greater and 60 minutes or less.

After bringing in contact with the liquid medium containing the cobalt compound, if necessary, the positive electrode active material raw material with the cobalt compound adhering thereto may be subjected to treatments such as filtration, water washing, and drying. A preliminary heat treatment may be performed depending on a type of the adhering cobalt compound. When the preliminary heat treatment is performed, the temperature is, for example, 100° C. or greater and 350° C. or less, preferably 120° C. or greater and 320° C. or less. The treatment time is, for example, 5 hours or more and 20 hours or less, preferably 8 hours or more and 15 hours or less. The atmosphere of the preliminary heat treatment is, for example, an atmosphere containing oxygen and may be the air atmosphere.

### Deposit Heat Treatment Step

In the deposit heat treatment step, the cobalt-adhered material obtained in the cobalt adhesion step is heat-treated at a predetermined temperature of 500° C. or greater and lower than 1100° C. to obtain a heat-treated material. The obtained heat-treated material is a positive electrode active material containing a lithium transition metal composite oxide having a high cobalt concentration near the surfaces of the particles. When a nonaqueous electrolyte secondary battery is formed using the obtained positive electrode active material, output characteristics at low SOC can be improved.

The cobalt-adhered material to be subjected to the heat treatment may be a mixture with a lithium compound. Therefore, the manufacturing method may include a mixing step of mixing the cobalt-adhered material and the lithium compound to obtain a mixture before the deposit heat treatment step. By heat-treating the cobalt-adhered material together with the lithium compound at a predetermined temperature, the output characteristics of the nonaqueous electrolyte secondary battery may further be improved.

The heat treatment of the cobalt-adhered material is performed at a temperature of, for example, 500° C. or greater and less than 1100° C. The heat treatment temperature is preferably 550° C. or greater, more preferably 600° C. or greater, and particularly preferably 630° C. or greater. The heat treatment temperature is preferably 1000° C. or less, more preferably 900° C. or less, further preferably 800° C. or less, and particularly preferably 750° C. or less. The heat treatment time is, for example, 1 hour or more and 20 hours or less, preferably 3 hours or more and 10 hours or less. The atmosphere of the heat treatment is, for example, an atmosphere containing oxygen, and may be the air atmosphere.

The heat-treated material resulting from the heat treatment may be subjected to treatments such as crushing, pulverization, classification operation, and granulating operation, if necessary.

The heat-treated material obtained as described above contains the secondary particles formed by aggregation of the plurality of primary particles containing a lithium transition metal composite oxide and has the smoothness of the secondary particles greater than 0.73 and the circularity of the secondary particles greater than 0.83, and the concentration of cobalt is high in the vicinity of the surfaces of the secondary particles. Therefore, in the secondary particles containing the lithium transition metal composite oxide, the ratio of the number of moles of cobalt to the total number of moles of metal elements other than lithium is higher in the second region at a depth of around 10 nm from the surface of the respective secondary particle than in the first region at a depth of around 150 nm from the surface of the respective secondary particle.

### Method of Manufacturing Nickel Composite Oxide

The nickel composite oxide supplied in the positive electrode active material raw material preparation step can be manufactured, for example, as follows. A method of manufacturing the nickel composite oxide includes, for example, a first solution preparation step of preparing a first solution containing nickel ions, a second solution preparation step of preparing a second solution containing a complex ion forming factor, a liquid medium preparation step of preparing a liquid medium having pH of 10 or greater and 13.5 or less, a crystallization step of supplying a polymer containing a constitutional unit derived from (meth)acrylic acid while separately and simultaneously supplying the first solution and the second solution to obtain a reaction solution having pH maintained in the range of 10 or greater and 13.5 or less, a composite hydroxide collection step of obtaining a composite hydroxide containing nickel from the reaction solution, and a composite hydroxide heat treatment step of heat-treating the obtained composite hydroxide to obtain the secondary particles formed by aggregation of the plurality of primary particles containing a complex oxide containing nickel. The smoothness of the secondary particles containing the manufactured nickel composite oxide is greater than 0.74.

### First Solution Preparation Step

In the first solution preparation step, the first solution containing nickel ions is prepared. The first solution is prepared by dissolving a predetermined amount of a salt containing metal elements in water in accordance with the composition of the intended nickel composite oxide. Examples of the type of salt include nitrates, sulfates, hydrochlorides, etc. When preparing the first solution, an acidic substance (e.g., a sulfuric acid aqueous solution) may be added to water. This may facilitate dissolving the salt containing metal elements. In the preparation of the first solution, a basic substance may further be added to adjust pH. The total number of moles of metal elements such as nickel in the first solution may appropriately be set in accordance with the average particle diameter of the intended nickel composite oxide. The total number of moles of metal elements indicates the total number of moles of nickel and cobalt when the first solution contains nickel and cobalt, and indicates the total number of moles of nickel, cobalt, and manganese when the first solution contains nickel, cobalt, and manganese.

The first solution may further contain at least one selected from the group consisting of cobalt ions, aluminum ions and manganese ions in addition to the nickel ions. In addition to these, the first solution may further contain ions of at least one second metal element M² selected from the group consisting of boron, sodium, magnesium, silicon, phosphorus, sulfur, potassium, calcium, titanium, vanadium, chromium, iron, copper, zinc, gallium, strontium, yttrium, zirconium, niobium, molybdenum, indium, tin, barium, lanthanum, cerium, neodymium, samarium, europium, gadolinium, lutetium, tantalum, tungsten, and bismuth. The second metal element may be at least one selected from the group consisting of zirconium, titanium, magnesium, tantalum, niobium, molybdenum, and tungsten.

The concentration of metal ions such as nickel in the first solution is, for example, 1.0 mol/L or greater and 2.6 mol/L or less, preferably 1.5 mol/L or greater and 2.2 mol/L or less as the total concentration of the metal ions. When the metal ion concentration of the first solution is 1.0 mol/L or greater, a sufficient amount of a crystallized material per reaction vessel can be obtained, so that the productivity may be improved. On the other hand, when the metal ion concentration of the first solution is 2.6 mol/L or less, the concentration is prevented from exceeding a saturation concentration of a metal salt at ordinary temperature, so that reduction in the metal ion concentration in the solution due to precipitation of metal salt crystals can be hindered.

### Second Solution Preparation Step

In the second solution preparation step, the second solution containing a complex ion forming factor is prepared. The second solution contains a complex ion forming factor that may form a complex ion with the metal ions contained in the first solution. For example, when the complex ion forming factor is ammonia, an ammonia aqueous solution can be used as the second solution. The content of ammonia contained in the ammonia aqueous solution is, for example, 5 mass % or greater and 25 mass % or less, preferably 10 mass % or greater and 20 mass % or less.

### Liquid Medium Preparation Step

In the liquid medium preparation step, a liquid medium having pH in the range of 10 or greater and 13.5 or less is prepared. The liquid medium is adjusted as a solution having pH of 10 or greater and 13.5 or less by using a predetermined amount of water and a basic solution such as a sodium hydroxide aqueous solution in a reaction vessel, for example. By adjusting the pH of the solution to 10 or greater and 13.5 or less, the pH fluctuation of the reaction solution at the initial stage of the reaction can be suppressed.

### Crystallization Step

In the crystallization step, the first solution and the second solution are separately and simultaneously supplied to the liquid medium while maintaining the pH of the formed reaction solution in the range of 10 or greater and 13.5 or less. At the same time, a polymer containing a constitutional unit derived from (meth)acrylic acid is supplied to the liquid medium. Accordingly, the composite hydroxide particles containing nickel can be obtained from the reaction solution. In addition to the first solution and the second solution, a basic solution may be supplied to the liquid medium at the same time. Accordingly, the reaction solution can easily be maintained to have the pH of 10 or greater and 13.5 or less.

In the crystallization step, the solutions are preferably supplied such that the pH of the reaction solution is maintained in the range of 10 or greater and 13.5 or less. the pH of the reaction solution can be maintained in the range of 10 or greater and 13.5 or less by, for example, adjusting the supply amount of the second solution in accordance with the supply amount of the first solution. When the pH of the reaction solution is lower than 10, an amount of impurity contained in the obtained composite hydroxide (e.g., sulfuric acid and nitric acid contents other than metals contained in the mixed solution) increases, which may lead a reduction in capacity of a secondary battery that is a final product. When the pH is higher than 13.5, many fine secondary particles are generated, which may deteriorate the handling of the obtained composite hydroxide. The temperature of the reaction solution may be controlled to be 25° C. or greater and 80° C. or less, for example.

In the crystallization step, the concentration of nickel ions in the reaction solution may be maintained, for example, to be 10 ppm or greater and 1000 ppm or less, preferably 10 ppm or greater and 100 ppm or less. When the concentration of nickel ions is 10 ppm or greater, the composite hydroxide is sufficiently precipitated. When the concentration of nickel ions is 1000 ppm or less, an amount of eluted nickel is small, so that deviation from the intended composition is suppressed. For example, when an ammonia aqueous solution is used as the complex ion forming solution, the nickel ion concentration can be adjusted by supplying the complex ion forming solution such that the ammonium ion concentration in the reaction solution is 1000 ppm or greater and 15,000 ppm or less.

The first solution may be supplied for a time of, for example, 6 hours or more and 60 hours or less, preferably 8 hours or more and 60 hours or less, and more preferably 10 hours or more and 42 hours or less. When supplying for 6 hours or more, the precipitation rate of the composite hydroxide becomes slow, so that the nickel composite oxide having higher smoothness tends to be obtained. When supplying for 60 hours or less, the productivity may further be improved.

A value of a fraction with the total number of moles of nickel, etc., in the first solution supplied throughout the crystallization step as a denominator and the total number of moles of nickel, etc. in the first solution supplied per hour as a numerator may be, for example, 0.015 or greater and 0.125 or less, preferably 0.020 or greater and 0.10 or less. When the value is 0.015 or greater, productivity may be improved. When the value is 0.125 or less, a nickel composite oxide having higher smoothness tends to be obtained.

The polymer containing a constitutional unit derived from (meth)acrylic acid supplied to the liquid medium may be, for example, an anionic polymer having a carboxy group that may function as a surfactant or a dispersant. With the polymer containing a constitutional unit derived from (meth)acrylic acid, foaming of the reaction solution can be reduced, and the smoothness and/or the circularity of the obtained composite hydroxide may be improved. For example, in the case of a nonionic dispersant generally used as a dispersant, foaming may occur in the reaction solution, making it difficult to control the particle diameter.

Examples of the constitutional unit derived from (meth)acrylic acid constituting the polymer include a constitutional unit derived from acrylic acid, a constitutional unit derived from methacrylic acid, a constitutional unit derived from acrylic acid ester, a constitutional unit derived from methacrylic acid ester, a constitutional unit derived from acrylic acid amide, and a constitutional unit derived from methacrylic acid amide. The polymer may further contain other constitutional units in addition to the constitutional unit derived from (meth)acrylic acid. Examples of other constitutional units comprise a constitutional unit derived from unsaturated dibasic acid or a constitutional unit derived from acid anhydride thereof.

The weight average molecular weight of the polymer may be, for example, 50000 or less, preferably 40000 or less, 30000 or less, or 20000 or less. The lower limit of the weight average molecular weight of the polymer may be, for example, 1000 or greater, preferably 3000 or greater, more preferably 6000 or greater. When the weight average molecular weight of the polymer is within the range, the particle diameter of the secondary particles tends to be more easily controlled and the smoothness tends to be higher.

The polymer may be supplied to the liquid medium as an alkali metal salt, an organic amine salt, an ammonium salt, etc. in which at least a portion of a carboxy group is neutralized with a neutralizing base such as an alkali metal ion such as sodium ion, an organic ammonium ion, or an ammonium ion. One type of the polymer may be used alone, or two or greater types may be used in combination. When two or greater types of polymers are used, the types may be a combination of different compositions, a combination of different weight average molecular weights, a combination of different neutralizing bases, or a combination thereof.

The polymer supplied to the liquid medium may be used in combination with other surfactants other than the polymer containing a constitutional unit derived from (meth)acrylic acid. Examples of the other surfactants comprise anionic surfactants having a phosphoric acid group, a sulfonic acid group, etc., cationic surfactants having a quaternary ammonium group etc., and nonionic surfactants. A supply amount of the other surfactant may be, for example, 10 mass % or less, preferably 1 mass % or less, relative to the supply amount of the polymer containing a constitutional unit derived from (meth)acrylic acid.

The amount of the polymer supplied to the liquid medium may be, for example, 0.5 mass % or greater and 5 mass % or less, preferably 1 mass % or greater and 3 mass % or less, relative to the total mass of the generated composite hydroxide. When the supply amount of the polymer is 0.5 mass % or greater relative to the total mass of the generated composite hydroxide, at least one of the smoothness and the circularity of the obtained composite hydroxide tends to be improved. When the supply amount is 5 mass % or less, the aggregation of the secondary particles in the crystallization step is suppressed, and at least one of the smoothness and the circularity of the obtained composite hydroxide tends to be further improved.

The polymer may be supplied to the liquid medium by supplying a polymer solution containing the polymer independently of the first solution and the second solution, or by supplying the polymer solution together with at least one of the first solution and the second solution. When supplied together with at least one of the first solution and the second solution, at least one of the first solution and the second solution may contain the polymer, or at least one of the first solution and the second solution and the polymer solution may be mixed and then supplied to the liquid medium. The content of the polymer in the solution used for supplying the polymer to the liquid medium may be, for example, 0.05 mass % or greater and 3.1 mass % or less, preferably 0.1 mass % or greater and 0.8 mass % or less, relative to the mass of the solution.

The crystallization step may comprise separately and simultaneously supplying the first solution and the second solution to the liquid medium, and supplying the polymer separately from and simultaneously with the first solution and the second solution or supplying the polymer together with at least one of the first solution and the second solution, in this order. In other words, portions of the first solution and the second solution may be separately and simultaneously supplied to the liquid medium before supplying the polymer. By supplying the first solution and the second solution to the liquid medium, the particle diameter of the nickel-containing composite hydroxide generated in the liquid medium can be controlled to a desired size. The composite hydroxide may be generated as a seed crystal, for example. By generating the composite hydroxide having a desired particle diameter in the liquid medium before the supply of the polymer, aggregation of the primary particles is suppressed, and at least one of the smoothness and the circularity of the composite hydroxide generated as the secondary particles tends to be more improved.

When the crystallization step comprises separately and simultaneously supplying the first solution and the second solution to the liquid medium before the supply of the polymer, the supply time of the first solution and the second solution before the supply of the polymer may be 2% or greater and 95% or less of the total supply time. The time is preferably 3% or greater and 40% or less, and more preferably 5% or greater and 20% or less. By setting the supply time of the first solution and the second solution before the supply of the polymer within this range, the composite hydroxide having a desired particle diameter can be generated in the liquid medium as described above, and the aggregation of the primary particles is suppressed so as to improve at least one of the smoothness and the circularity.

The method of manufacturing the nickel composite oxide may comprise a seed crystal formation step before the crystallization step. In the seed crystal formation step, for example, a portion of the prepared first solution is supplied to the liquid medium to generate a composite hydroxide containing nickel in the liquid medium, for example, as a seed crystal. Therefore, the liquid medium provided in the crystallization step may be a seed solution containing a composite hydroxide.

When composite hydroxide particles are generated in the liquid medium before the crystallization step, one particle of the composite hydroxide generated in advance serves as a seed crystal constituting one particle of the composite hydroxide obtained after the crystallization step. Thus, the total number of the secondary particles of the composite hydroxide obtained after the crystallization step can be controlled by the number of the composite hydroxide particles generated in advance. For example, if a large amount of the first solution is supplied in advance, the number of the generated composite hydroxide particles increases, so that the average particle diameter of the secondary particles of the composite hydroxide after the crystallization step tends to decrease. For example, if the pH of the initial liquid medium is made higher than the pH of the obtained reaction solution, the formation of the composite hydroxide particles is prioritized over the growth of the composite hydroxide particles. As a result, the composite hydroxide particles having a more uniform particle diameter are generated, and the composite hydroxide particles having a narrower particle size distribution can be obtained.

In the crystallization step, the first solution, the second solution, and the polymer solution may continuously or intermittently be supplied to the liquid medium. From the viewpoint of improving the circularity and the smoothness, preferably, the first solution is supplied continuously throughout the supply time of the first solution in the crystallization step. The phrase “continuously throughout the supply time” as used herein means that almost no unsupplied time exists throughout the supply time. The phrase “almost no unsupplied time exists” means that the unsupplied time is less than 1% of the total supply time.

### Composite Hydroxide Collection Step

In the composite hydroxide collection step, the composite hydroxide containing nickel is separated from the reaction solution and collected. The complex hydroxide can be collected from the reaction solution by, for example, a commonly used separation means such as filtration or centrifugation of the generated precipitate. The obtained precipitate may be subjected to treatments such as water washing, filtration, and drying. A composition ratio of metal elements in the composite hydroxide may be substantially the same as the composition ratio of the metal elements in the lithium transition metal composite oxide obtained by using the composite hydroxide as a raw material.

The obtained composite hydroxide may have a ratio of the number of moles of nickel to the total number of moles of metal elements contained in the composite hydroxide greater than 0 and less than 1, for example. The ratio of the number of moles of nickel to the total number of moles of metal elements is preferably 0.3 or greater, or 0.33 or greater. The ratio of the number of moles of nickel to the total number of moles of metal elements may be 0.6 or greater. The ratio of the number of moles of nickel to the total number of moles of metal elements is preferably 0.98 or less, or 0.95 or less.

The obtained composite hydroxide may have a ratio of the number of moles of cobalt to the total number of moles of metal elements contained in the composite hydroxide of 0 or greater and 0.5 or less. The ratio of the number of moles of cobalt to the total number of moles of metal elements is preferably 0.01 or greater, 0.02 or greater, 0.03 or greater, or 0.04 or greater. The ratio of the number of moles of cobalt to the total number of moles of metal elements is preferably 0.4 or less. The ratio of the number of moles of cobalt to the total number of moles of metal elements may be 0.3 or less, 0.2 or less, or 0.1 or less.

The composite hydroxide may contain at least one of manganese and aluminum in its composition. In the composite hydroxide, the ratio of the total number of moles of manganese and aluminum to the total number of moles of metal elements is, for example, 0 or greater, preferably 0.01 or greater, more preferably 0.02 or greater, further preferably 0.03 or greater. The ratio of the total number of moles of manganese and aluminum to the total number of moles of metal elements is, for example, 0.5 or less. The ratio of the total number of moles of manganese and aluminum to the total number of moles of metal elements may be 0.3 or less, 0.2 or less, or 0.1 or less.

The composite hydroxide may contain at least one second metal element in its composition. In the composite hydroxide, a ratio of the total number of moles of the second metal element to the total number of moles of metal elements is, for example, 0 or greater, preferably 0.001 or greater, more preferably 0.003 or greater. The ratio of the total number of moles of the second metal element to the total number of moles of metal elements is, for example, 0.1 or less, preferably 0.05 or less, more preferably 0.01 or less.

The composite hydroxide may have a composition represented by Formula (3), for example.

NiⱼCoₖM¹ₘM²ₙ(OH)_{2+γ} (3)

In Formula (3), M¹ denotes at least one of Mn and Al. M² denotes at least one selected from the group consisting of B, Na, Mg, Si, P, S, K, Ca, Ti, V, Cr, Fe, Cu, Zn, Ga, Sr, Y, Zr, Nb, Mo, In, Sn, Ba, La, Ce, Nd, Sm, Eu, Gd, Lu, Ta, W, and Bi. Additionally, j, k, m, n, and γ satisfy 0.3≤j≤1, 0≤k≤0.5, 0≤m≤0.5, 0≤n≤0.1, 0≤γ≤1. Preferably, 0.33≤j≤0.98, 0.01≤k≤0.4, 0.01≤m≤0.3, 0≤n≤0.1, and more preferably 0.6≤j≤0.98, 0.03≤k≤0.2, 0.03≤m≤0.1, 0.001≤n≤50.05. Preferably, M² is at least one selected from the group consisting of Zr, Ti, Mg, Ta, Nb, Mo, and W.

### Composite Hydroxide Heat Treatment Step

In the composite hydroxide heat treatment step, the obtained composite hydroxide is heat-treated to obtain a nickel composite oxide containing the secondary particles formed by aggregation of the plurality of primary particles containing the composite oxide containing nickel. By the heat treatment, the composite hydroxide is dehydrated to generate the nickel composite oxide. The nickel composite oxide may be a precursor of a lithium transition metal composite oxide or may be a positive electrode active material precursor.

The temperature of the heat treatment may be, for example, 105° C. or greater and 900° C. or less, preferably 300° C. or greater and 500° C. or less. The time of the heat treatment may be, for example, 5 hours or more and 30 hours or less, preferably 10 hours or more and 20 hours or less. The atmosphere of the heat treatment may be an atmosphere containing oxygen and may be the air atmosphere.

The smoothness of the obtained secondary particles containing the nickel composite oxide may be, for example, greater than 0.74, preferably 0.80 or greater, or 0.85 or greater. The circularity of the secondary particles containing the nickel composite oxide is, for example, 0.80 or greater, preferably 0.85 or greater, or 0.87 or greater. The smoothness and the circularity of the secondary particles containing the nickel composite oxide are measured in the same manner as those in the secondary particles constituting the positive electrode active material. The upper limit of the smoothness and the circularity of the secondary particles is 1 or less and may be less than 1.

The particle size distribution value of the secondary particles containing the nickel composite oxide, as a value ((D₉₀-D₁₀)/D₅₀) obtained by dividing a difference between the 90% particle diameter D₉₀ and the 10% particle diameter D₁₀ by the 50% particle diameter D₅₀ in the volume-based cumulative particle size distribution, is, for example, less than 0.8, preferably 0.7 or less, 0.6 or less, or 0.5 or less.

The volume average particle diameter of the secondary particles containing the nickel composite oxide is, for example, 1 μm or greater and 30 μm or less, preferably 1.5 μm or greater, more preferably 2 μm or greater, further preferably 3 μm or greater, and preferably 18 μm or less, more preferably 12 μm or less, further preferably 8 μm or less. The volume average particle diameter of the secondary particles within the range results in good fluidity and may further improve output when the secondary battery is formed. The volume average particle diameter is the 50% particle diameter D₅₀ corresponding to 50% accumulation from the small diameter side in the volume-based cumulative particle size distribution.

The secondary particles containing the nickel composite oxide are formed by aggregation of the plurality of primary particles. The average particle diameter D_{SEM} of the primary particles based on electron microscope observation is, for example, 0.1 μm or greater and 1.5 μm or less, preferably 0.12 μm or greater, more preferably 0.15 μm or greater. The average particle diameter D_{SEM} of the primary particles based on electron microscope observation is preferably 1.2 μm or less, more preferably 1.0 μm or less. When the average particle diameter of the primary particles based on electron microscope observation is within the range, the output may be improved when the battery is formed.

The secondary particles containing the nickel composite oxide may have the ratio D₅₀/D_{SEM} of the 50% particle diameter D₅₀ in the volume-based cumulative particle size distribution to the average particle diameter D_{SEM} based on electron microscope observation of 2.5 or greater, for example. The ratio D₅₀/D_{SEM} is, for example, 2.5 or greater and 150 or less, preferably 5 or greater, more preferably 10 or greater. The ratio D₅₀/D_{SEM} is preferably 100 or less, more preferably 50 or less.

The nickel composite oxide may have a ratio of the number of moles of nickel to the total number of moles of metal elements contained in the nickel composite oxide greater than 0 and less than 1, for example. The ratio of the number of moles of nickel to the total number of moles of metal elements is preferably 0.3 or greater, or 0.33 or greater. The ratio of the number of moles of nickel to the total number of moles of metal elements may be 0.6 or greater. The ratio of the number of moles of nickel to the total number of moles of metal elements is preferably 0.98 or less, or 0.95 or less.

The nickel composite oxide may have a ratio of the number of moles of cobalt to the total number of moles of metal elements contained in the nickel composite oxide of 0 or greater and 0.5 or less. The ratio of the number of moles of cobalt to the total number of moles of metal elements is preferably 0.01 or greater, 0.02 or greater, 0.03 or greater, or 0.04 or greater. The ratio of the number of moles of cobalt to the total number of moles of metal elements is preferably 0.4 or less. The ratio of the number of moles of cobalt to the total number of moles of metal elements may be 0.3 or less, 0.2 or less, or 0.1 or less.

The nickel composite oxide may contain at least one of manganese and aluminum in its composition. In the nickel composite oxide, the ratio of the total number of moles of manganese and aluminum to the total number of moles of metal elements is, for example, 0 or greater, preferably 0.01 or greater, more preferably 0.02 or greater, further preferably 0.03 or greater. The ratio of the total number of moles of manganese and aluminum to the total number of moles of metal elements is, for example, 0.5 or less, and may be 0.3 or less, 0.2 or less, or 0.1 or less.

The nickel composite oxide may contain at least one second metal element in its composition. In the nickel composite oxide, the ratio of the total number of moles of the second metal element to the total number of moles of the metal element is, for example, 0 or greater, preferably 0.001 or greater, more preferably 0.003 or greater. The ratio of the total number of moles of the second metal element to the total number of moles of the metal element is, for example, 0.1 or less, preferably 0.05 or less, more preferably 0.01 or less.

The nickel composite oxide may have a composition represented by Formula (4), for example.

Ni_{q}CoᵣM¹ₛM²ₜO₂ (4)

In Formula (4), M¹ denotes at least one of Mn and Al. M² denotes at least one selected from the group consisting of B, Na, Mg, Si, P, S, K, Ca, Ti, V, Cr, Fe, Cu, Zn, Ga, Sr, Y, Zr, Nb, Mo, In, Sn, Ba, La, Ce, Nd, Sm, Eu, Gd, Lu, Ta, W, and Bi. Additionally, q, r, s, and t satisfy 0.3≤q<1, 0≤r≤0.5, 0≤s≤0.5, 0≤t≤0.1, and q+r+s+t≤1.1. Preferably, q, r, s, and t satisfy 0.33≤q≤0.98, 0.01≤r≤0.4, 0.01≤s≤0.3, 0≤t≤0.1, more preferably 0.6≤q≤0.98, 0.03≤r≤0.2, 0.03≤s≤0.1, 0.001≤t≤0.05. Preferably, M² is at least one selected from the group consisting of Zr, Ti, Mg, Ta, Nb, Mo, and W.

### Electrode for Nonaqueous Electrolyte Secondary Battery

An electrode for a nonaqueous electrolyte secondary battery comprises a collector and a positive electrode active material layer disposed on the collector and containing the positive electrode active material for a nonaqueous secondary battery manufactured by the manufacturing method. The nonaqueous electrolyte secondary battery comprising the electrode can improve the output characteristics at low SOC.

Examples of the material of the collector comprise aluminum, nickel, stainless steel, etc. The positive electrode active material layer is formed by applying a positive electrode composition obtained by mixing the positive electrode active material described above, a conductive material, a binder, etc. together with a solvent onto the collector and performing a drying treatment, a pressure treatment, etc. Examples of the conductive material comprise natural graphite, artificial graphite, acetylene black, etc. Examples of the binder comprise polyvinylidene fluoride, polytetrafluoroethylene, and polyamide acrylic resin.

### Nonaqueous Electrolyte Lithium-Ion Secondary Battery

A nonaqueous electrolyte lithium-ion secondary battery comprises a positive electrode containing a positive electrode active material for a nonaqueous electrolyte secondary battery, a negative electrode, and a nonaqueous electrolyte. The positive electrode comprises a collector and a positive electrode active material layer disposed on the collector and containing the positive electrode active material for a nonaqueous secondary battery described above. The nonaqueous electrolyte secondary battery comprising the positive electrode can improve the output characteristics at low SOC.

Examples of the material of the collector comprise aluminum, nickel, stainless steel, etc. The positive electrode active material layer is formed by applying a positive electrode composition obtained by mixing the positive electrode active material described above, a conductive material, a binder, etc. together with a solvent onto the collector and performing a drying treatment, a pressure treatment, etc. Examples of the conductive material comprise natural graphite, artificial graphite, acetylene black, etc. Examples of the binder comprise polyvinylidene fluoride, polytetrafluoroethylene, and polyamide acrylic resin.

The nonaqueous electrolyte secondary battery is configured to comprise, in addition to the positive electrode, a negative electrode, a nonaqueous electrolyte, a separator, etc. For the negative electrode, the nonaqueous electrolyte, the separator, etc., in the nonaqueous electrolyte secondary battery, for example, those for a nonaqueous secondary battery described in Japanese Laid-Open Patent Publication Nos. 2002-075367, 2011-146390, and 2006-12433 (incorporated herein by reference in their entirety) may appropriately be used.

The present disclosure is not limited to the embodiments. The embodiments are exemplifications, and any of those having substantially the same configuration as the technical idea described in the claims of the present disclosure and providing the same effects are obviously comprised in the technical scope of the present disclosure.

### EXAMPLES

The present disclosure will hereinafter specifically be described with reference to examples; however, the present disclosure is not limited to these examples.

The primary particle size, i.e., the average particle diameter D_{SEM} based on electron microscope observation of the primary particles, was measured as follows. By using a scanning electron microscope (SEM), the primary particles constituting the secondary particles were observed at a magnification in the range of 1000 times to 15000 times depending on the particle size. Fifty primary particles whose contours were able to be confirmed in the observation were selected. A contour length is obtained by tracing the contour of the selected primary particle by using image processing software. A sphere conversion diameter was calculated from the contour length, and the average particle diameter D_{SEM} based on the electron microscope observation of the primary particles was obtained as the arithmetic mean value of the obtained sphere conversion diameter.

The 10% particle diameter D₁₀, the 50% particle diameter D₅₀, and the 90% particle diameter D₉₀ in the volume-based cumulative particle size distribution were obtained by measuring the volume-based cumulative particle size distribution under wet conditions accumulation by using a laser diffraction particle size distribution measuring device (SALD-3100 manufactured by Shimadzu Corporation) as the particle diameters respectively corresponding to 10%, 50%, and 90% of accumulation from the small diameter side. The particle size distribution value was calculated by dividing the difference between D₉₀ and D₁₀ by D₅₀. Specifically, the particle size distribution value of the secondary particles was calculated by the following equation.

Particle size distribution value=(D₉₀-D₁₀)/D₅₀

The smoothness was measured as follows. After curing epoxy filled with the positive electrode active material, cross-section processing was performed to prepare a cross-section sample. A backscattered electron image (magnification: 4000 times) was taken by using a scanning electron microscope (Hitachi High-Technologies SU8230; acceleration voltage: 3 kV). In the obtained backscattered electron image, 20 to 40 secondary particles whose contours were able to be confirmed in the image were selected, and the total circumference Lₒₚ was measured for each particle by using image processing software (ImageJ). For the contours of the selected particles, the best-fitting (approximate) ellipse was obtained by using the image processing software (ImageJ), and the major axis a and the minor axis b of the approximate ellipse were obtained for each of the particles. From the obtained major axis a and minor axis b, the total circumference L of the approximate ellipse was determined by using the approximation formula of the formula of Gauss-Kummer. The smoothness was obtained as the ratio (L/Lₒₚ) of the total circumference (L) of the approximate ellipse to the total circumference (Lₒₚ) of the contour of the particle image. The smoothness of the secondary particles was calculated as the arithmetic mean of the smoothness of the individual particles.

The circularity was obtained as the ratio (L₁/L₀) of the circumference (L₁) calculated from an equivalent circle diameter to the total circumference (L₀) of the contour shape of the secondary particle when a diameter of a circle having the same area as a particle image area in the contour shape of the secondary particle is defined as the equivalent circle diameter. More specifically, by using a dry particle image analyzer (Morphologi G3S: Malvern: lens magnification: 20 times), respective circularities of about 10,000 particles were measured, the arithmetic mean value of the circularities was determined as the circularity of the secondary particles.

A tap density was measured as follows. 20 g of a sample was put into a 20 mL measuring cylinder, and tapping was performed 150 times from a height of 6.5 cm. After the tapping, the volume was measured, and a density is determined. The determined density was defined as the tap density. A bulk density was measured as follows. A sample passed through a sieve (aperture: 0.5 mm) was placed in a container having a capacity of 30 mL until a heap is formed, and a heaping portion of the sample was removed with a spatula. The weight of the sample remaining in the container was measured, and the bulk density was determined.

The specific surface area was measured by the nitrogen gas adsorption method (one-point method) using a BET specific surface area measuring device (Macsorb Model-1201 manufactured by Mountech Co., Ltd.).

### Example 1

### Preparation of Solutions

A mixed solution (combined concentration of nickel, cobalt, and manganese of 1.7 mol/L; first solution) as prepared by mixing a nickel sulfate solution, a cobalt sulfate solution, and a manganese sulfate solution at the molar ratio of metal elements of 9.2:0.4:0.4. The total number of moles of metal elements in the mixed solution was 474 moles. A 25 mass % sodium hydroxide aqueous solution was prepared as a basic aqueous solution. A 12.5 mass % ammonia aqueous solution (second solution) was prepared as a complex ion forming solution. A polymer solution was prepared by blending the surfactants Aron A-30SL (manufactured by Toagosei Company, Limited; 40 mass % aqueous solution of ammonium polyacrylate, weight average molecular weight=6000) and Aron A-210 (manufactured by Toagosei Company, Limited; 43 mass % aqueous solution of ammonium polyacrylate, weight average molecular weight=3000) at a mass ratio of 1:1.

### Preparation of Liquid Medium

30 liters of water was provided in a reaction vessel, and a sodium hydroxide aqueous solution was added such that pH became 12.5. Nitrogen gas was introduced for replacement with nitrogen inside the reaction vessel to prepare a liquid medium.

### Seed Crystal Formation Step

While stirring the liquid medium, 2 mol of the first solution was added to the liquid medium as the total number of moles of metal elements to precipitate a composite hydroxide containing nickel, cobalt, and manganese.

### Crystallization Step

While stirring the prepared liquid medium containing the composite hydroxide, the remaining 472 mol of the first solution, the sodium hydroxide aqueous solution, and the ammonia aqueous solution (second solution) were supplied separately and simultaneously while maintaining the basicity (pH 11.3). The polymer solution was supplied after 3 hours from the start of the supply of the first solution, the second solution, and the sodium hydroxide aqueous solution, and a composite hydroxide containing nickel, cobalt, and manganese was precipitated. The supply amount of the polymer solution was 1 mass % as a supply amount of the polymer relative to the theoretical yield of the generated composite hydroxide. The supply of the first solution was continuously performed for 18 hours. In the crystallization step, the temperature of the liquid medium was controlled to be about 50° C.

The precipitate was collected, and then washed with water, filtered, and dried to obtain a composite hydroxide containing nickel, cobalt, and manganese (hereinafter also referred to as nickel composite hydroxide).

### Manufacture of Nickel Composite Oxide

The nickel composite hydroxide was heat-treated at 320° C. for 16 hours in the air atmosphere and collected as a transition metal composite oxide containing nickel, cobalt, and manganese (hereinafter also referred to as nickel composite oxide).

The obtained nickel composite oxide was dissolved in an inorganic acid and then subjected to a chemical analysis by ICP emission spectroscopy, and the composition thereof was Ni_{0.921}Co_{0.040}Mn_{0.039}O₂. When the physical properties of the obtained nickel composite oxide were evaluated as described above, the 50% particle diameter D₅₀ was 6.2 μm, the circularity was 0.89, and the smoothness was 0.76.

Lithium hydroxide and the nickel composite oxide obtained as described above were dry-mixed to obtain a lithium mixture so that the molar ratio of lithium hydroxide to the nickel composite oxide was 1.10. The obtained lithium mixture was heat-treated at 740° C. for 5 hours in an oxygen atmosphere (oxygen concentration: 40 vol. %) to perform the synthesis step. Subsequently, a dispersion treatment was performed to obtain a lithium transition metal composite oxide as the positive electrode active material raw material.

The obtained lithium transition metal composite oxide was dissolved in an inorganic acid and then subjected to a chemical analysis by ICP emission spectroscopy, and the composition thereof was Li_{1.10}Ni_{0.921}Co_{0.040}Mn_{0.039}O₂. When the physical properties of the obtained lithium transition metal composite oxide were evaluated as described above, the 50% particle diameter D₅₀ was 6.26 μm, the circularity was 0.86, and the smoothness was 0.76.

Cobalt oxide was added to the obtained lithium transition metal composite oxide at a proportion of 3 mol % and mixed by a mixer to obtain a cobalt-adhered material. Subsequently, the cobalt-adhered material was heat-treated at 665° C. for 5 hours in an oxygen atmosphere (oxygen concentration: 40 vol. %). The obtained heat-treated material was subjected to a dispersion treatment with a resin ball mill so as to have the same volume average particle diameter as the positive electrode active material raw material after the synthesis step and is sieved through a dry sieve to obtain a lithium transition metal composite oxide having a deposit containing Co on the surface as the positive electrode active material.

The obtained positive electrode active material was dissolved in an inorganic acid and then subjected to a chemical analysis by ICP emission spectroscopy, and the composition thereof was Li_{1.06}Ni_{0.894}Co_{0.068}Mn_{0.038}O₂. When the physical properties of the obtained lithium transition metal composite oxide were evaluated as described above, the 50% particle diameter D₅₀ was 6.35 μm, the circularity was 0.84, and the smoothness was 0.74.

### Comparative Example 1

The lithium transition metal composite oxide serving as the positive electrode active material raw material in Example 1 was used as the positive electrode active material in Comparative Example 1.

### Evaluation of Cobalt Distribution and Nickel Distribution

For the positive electrode active material obtained as described above, the cobalt distribution and the nickel distribution inside the particles were evaluated. Specifically, the nickel content and the cobalt content in the first region and the second region were evaluated as follows.

### Composition Analysis

After each of the positive electrode active materials obtained in Example 1 and Comparative Example 1 was dispersed and solidified in an epoxy resin, a cross section of the secondary particle of the positive electrode active material was exposed by using a cross section polisher (manufactured by JEOL Ltd.) to produce a measurement sample. At one point in each of the first region (150 nm deep from the surface) and the second region (10 nm deep from the surface) of the measurement sample, an intensity ratio of each of the metal components other than lithium was obtained by a scanning electron microscope (SEM)/energy dispersive X-ray analysis (EDX) device (manufactured by Hitachi High-Tech Corporation; acceleration voltage: 3 kV). The cobalt ratio (Co ratio) was defined as an intensity ratio of cobalt to the total intensity ratio of metal components other than lithium, and the nickel ratio (Ni ratio) was defined as an intensity ratio of nickel to the total intensity ratio of metal components other than lithium. The results are shown in Table 1.

TABLE 1

| | | | Comparative |
|---|---|---|---|
| | | Example 1 | Example 1 |
| D_{SEM} (mm) | | 0.36 | 0.43 |
| D₁₀ (mm) | | 4.40 | 4.35 |
| D₅₀ (mm) | | 6.35 | 6.26 |
| D₉₀ (mm) | | 9.25 | 9.31 |
| Particle size distribution | | 0.76 | 0.79 |
| Smoothness | | 0.74 | 0.76 |
| Circularity | | 0.84 | 0.86 |
| Specific surface area | | 0.81 | 0.82 |
| (m²/g) | | | |
| Tap density (g/cm³) | | 1.81 | 1.87 |
| Bulk density (g/cm³) | | 0.98 | 1.01 |
| Co ratio | First region | 0.026 | 0.034 |
| | Second region | 0.176 | 0.035 |
| Ni ratio | First region | 0.919 | 0.885 |
| | Second region | 0.776 | 0.885 |

In the positive electrode material of the example 1, the smoothness of the secondary particles constituting the positive electrode active material is greater than 0.73 and the circularity is greater than 0.83. This suggests that, for example, the cobalt-containing deposit is adhered uniformly to a surface of the lithium transition metal composite oxide and the output at low SOC is improved. Assembly of Evaluation Batteries

Output characteristics of evaluation batteries comprising the positive electrode containing the positive electrode active material of Example 1 and Comparative Example 1 were evaluated by measuring DC-IR (DC internal resistance). The measurement was performed by assembling the evaluation batteries as will be described below and using the obtained evaluation batteries.

### Fabrication of Positive Electrode

A positive electrode slurry was prepared by dispersing and dissolving 96.5 parts by mass of the positive electrode active material, 1.5 parts by mass of acetylene black, and 2 parts by mass of PVDF (polyvinylidene fluoride) in NMP (N-methyl-2-pyrrolidone). The obtained positive electrode slurry is applied to a collector made of aluminum foil, dried, compression-molded by a roll press machine to achieve the density of the positive electrode active material layer of 3.5 g/cm³, and then cut into a size of 15 cm² to obtain a positive electrode.

### Fabrication of Negative Electrode

A negative electrode slurry was prepared by dispersing 97.5 parts by mass of artificial graphite, 1.5 parts by mass of CMC (carboxymethyl cellulose), and 1.0 part by mass of SBR (styrene butadiene rubber) in water. The obtained negative electrode slurry was applied to a copper foil, dried, and further compression-molded to obtain a negative electrode.

### Preparation of Nonaqueous Electrolytic Solution

EC (ethyl carbonate) and EMC (ethyl methyl carbonate) are mixed at a volume ratio of 3:7 to obtain a mixed solvent. Lithium hexafluorophosphate (LiPF₆) was dissolved at a concentration of 1.0 mol in the obtained mixed solvent to obtain a nonaqueous electrolytic solution.

### Fabrication of Evaluation Batteries

After respective lead electrodes were attached to the collectors of the positive and negative electrodes, vacuum drying was performed at 120° C. Subsequently, a separator is arranged between the positive electrode and the negative electrode, and these were stored in a bag-shaped laminate pack. After storage, vacuum drying was performed at 60° C. to remove water adsorbed in the members. Subsequently, the nonaqueous electrolytic solution was injected and sealed in the laminate pack under an argon atmosphere to fabricate the evaluation battery.

### Aging

The evaluation battery was subjected to a constant voltage constant current charge (cutoff current: 0.05 C) with a charge voltage of 4.2 V and a charge current of 0.1 C (1 C is a current with which discharge is completed in 1 hour) and a constant current discharge with a discharge end voltage of 2.5V and a discharge current of 0.1 C to apply the nonaqueous electrolytic solution to the positive electrode and the negative electrode.

### Measurement of DC Internal Resistance

The evaluation battery after aging was placed in an environment of 25° C., and a DC internal resistance (DC-IR) was measured. After a constant current charge was performed to the state-of-charge (SOC) of 95% at a full charge voltage of 4.2 V, a release potential at the SOC of 95% was measured. Subsequently, a pulse discharge with a specific current value i was performed for 30 seconds, and a voltage V after 10 seconds was measured. The DC internal resistance (DC-IR) was calculated from a difference between the release potential and the voltage V after 10 seconds. This constant current charge was performed to each of the SOCs of 95%, 80%, 50%, 20%, 10%, and 5%, and the DC internal resistance at each SOC was measured. The current value i at the SOCs of 95%, 10%, and 5% was 0.07 A, and the current value i at the SOCs of 80%, 50%, and 20% was 0.12 A. Table 2 shows the relative resistance values at respective SOCs when the DC internal resistance at the SOC 5% of Comparative Example 1 is 1.

TABLE 2

| | Relative resistance value | | | | | |
|---|---|---|---|---|---|---|
| | SOC95% | SOC80% | SOC50% | SOC20% | SOC10% | SOC5% |
| Example 1 | 0.233 | 0.253 | 0.237 | 0.253 | 0.322 | 0.463 |
| Comparative | 0.234 | 0.246 | 0.231 | 0.251 | 0.387 | 1 |
| Example 1 | | | | | | |

As shown in Table 2, when the cobalt concentration difference between the surface and the inside is at a certain level or greater in those having specific smoothness and circularity, the output at low SOC is improved.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

Although the present disclosure has been described with reference to several exemplary embodiments, it is to be understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular examples, means, and embodiments, the disclosure may be not intended to be limited to the particulars disclosed; rather the disclosure extends to all functionally equivalent structures, methods, and uses such as are within the scope of the appended claims.

One or more examples or embodiments of the disclosure may be referred to herein, individually and/or collectively, by the term “disclosure” merely for convenience and without intending to voluntarily limit the scope of this application to any particular disclosure or inventive concept. Moreover, although specific examples and embodiments have been illustrated and described herein, it should be appreciated that any subsequent arrangement designed to achieve the same or similar purpose may be substituted for the specific examples or embodiments shown. This disclosure may be intended to cover any and all subsequent adaptations or variations of various examples and embodiments. Combinations of the above examples and embodiments, and other examples and embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure may be not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter shall be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure may be determined by the broadest permissible interpretation of the following claims and their equivalents, and shall not be restricted or limited by the foregoing detailed description.

All publications, patent applications, and technical standards mentioned in this specification are herein incorporated by reference to the same extent as if each individual publication, patent application, or technical standard was specifically and individually indicated to be incorporated by reference.

What is claimed is:

1. A positive electrode active material for a nonaqueous electrolyte secondary battery comprising:
secondary particles formed by aggregation of a plurality of primary particles containing a lithium transition metal composite oxide, the lithium transition metal composite oxide having a layered structure and containing lithium and nickel, wherein
the secondary particles have a smoothness greater than 0.73 and a circularity greater than 0.83,
the secondary particles contain cobalt,
each of the secondary particles has a first region at a depth of 150 nm from a surface of the respective secondary particle and a second region at a depth of 10 nm or less from the surface of the respective secondary particle, and
a ratio of a number of moles of cobalt to a total number of moles of metal elements other than lithium in the second region is larger than a ratio of a number of moles of cobalt to a total number of moles of metal elements other than lithium in the first region.

2. The positive electrode active material according to claim 1, wherein a difference between the ratio of the number of moles of cobalt to the total number of moles of metal elements other than lithium in the second region and the ratio of the number of moles of cobalt to the total number of moles of metal elements other than lithium in the first region is 0.02 or greater.

3. The positive electrode active material according to claim 1, wherein a value obtained by dividing the ratio of the number of moles of cobalt to the total number of moles of metal elements other than lithium in the second region by the ratio of the number of moles of cobalt to the total number of moles of metal elements other than lithium in the first region is 2 or greater.

4. The positive electrode active material according to claim 1, wherein the secondary particles have a volume average particle diameter of 1 μm or greater and 30 μm or less.

5. The positive electrode active material according to claim 1, wherein a value obtained by dividing a difference between a 90% particle diameter D₉₀ and a 10% particle diameter D₁₀ by a 50% particle diameter D₅₀ in a volume-based cumulative particle size distribution of the secondary particles is less than 0.9.

6. The positive electrode active material according to claim 1, wherein
the positive electrode active material has a composition in which a ratio of a number of moles of nickel to a total number of moles of metal elements other than lithium is greater than 0 and less than 1, and
a ratio of a number of moles of cobalt to the total number of moles of metal elements other than lithium is greater than 0 and 0.5 or less.

7. The positive electrode active material according to claim 1, having a composition represented by Formula (1):
LiₚNiₓCo_{y}M¹_{z}M²_{w}O₂ (1)
wherein 0.95≤p≤1.5, 0<x<1, 0<y≤0.5, 0≤z≤0.5, 0≤w≤0.1, and x+y+z+w≤1, M¹ is at least one selected from the group consisting of Al and Mn, and M² is at least one selected from the group consisting of B, Na, Mg, Si, P, S, K, Ca, Ti, V, Cr, Fe, Cu, Zn, Ga, Sr, Y, Zr, Nb, Mo, In, Sn, Ba, La, Ce, Nd, Sm, Eu, Gd, Lu, Ta, W, and Bi.

8. A method of manufacturing a positive electrode active material for a nonaqueous electrolyte secondary battery, the method comprising:
preparing a positive electrode active material raw material containing secondary particles formed by aggregation of a plurality of primary particles containing a lithium transition metal composite oxide, the lithium transition metal composite oxide having a layered structure and containing lithium and nickel, the secondary particles having a smoothness greater than 0.73, the secondary particles having a circularity greater than 0.83;
bringing the positive electrode active material raw material into contact with a cobalt compound to obtain a cobalt-adhered material in which the cobalt compound is adhered to a surface of the lithium transition metal composite oxide contained in the positive electrode active material raw material; and
heat-treating the cobalt-adhered material at a temperature of 500° C. or greater and lower than 1100° C. to obtain a heat-treated material.

9. A nonaqueous electrolyte lithium-ion secondary battery comprising: a positive electrode containing the positive electrode active material according to claim 1, a negative electrode, and a nonaqueous electrolyte.
